(19) United States
(12) Patent Application Publication
(10) Pub. No.: US 2014/0003674 A1
(43) Pub. Date: Jan. 2, 2014

(54) Skin-Based User Recognition

(71) Applicant: Christopher D. Coley, Morgan Hill, CA (US)

(72) Inventor: Christopher D. Coley, Morgan Hill, CA (US)

(21) Appl. No.: 13/534,915

(22) Filed: Jun. 27, 2012

(51) Int. Cl. G06K 9/62

(52) U.S. Cl. 382/115

(57) ABSTRACT

Techniques are described for recognizing users based on optical or visual characteristics of their hands. When a user's hand is detected within an area, an image of the hand is captured and analyzed to detect or evaluate skin properties. Such skin properties are recorded and associated with a particular user for future recognition of that user. Recognition such as this may be used for user identification, for distinguishing between multiple users of a system, and/or for authenticating users.

### BACKGROUND

Digital content, such as movies, images, books, interactive content, and so on, may be displayed and consumed in various ways. In some situations, it may be desired to display content on passive surfaces within an environment, and to interact with users in response to hand gestures, spoken commands, and other actions that do not involve traditional input devices such as keyboards.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an environment that includes an augmented reality functional node (ARFN) that projects content onto a display surface and that recognizes users based on skin characteristics of their hands.

FIG. 2 is a top view of a display area that may be projected by the ARFN onto a display surface, showing a user's arm and hand over the display area.

FIG. 3 is an example flow diagram of an ARFN recognizing a user based on skin characteristics of the user's hand.

### DETAILED DESCRIPTION

This disclosure describes a systems and techniques for interacting with users using passive elements of an environment. For example, various types of content may be projected onto a passive surface within a room, such as the top of a table or a handheld sheet. Content may include images, video, pictures, movies, text, books, diagrams, Internet content, user interfaces, and so forth.

A user within such an environment may direct the presentation of content by speaking, performing gestures, touching the passive surface upon which the content is displayed, and in other ways that do not involve dedicated input devices such as keyboards.

As a user acts within this environment and issues commands with hand gestures, an image of the user's hand may be captured and analyzed in order to recognize the user. Recognition may be performed for various purposes, such as for identifying a user, for distinguishing a user from among multiple concurrent users in the environment, and/or for authenticating a user.

Various optical or visual properties of a hand may be used for user recognition. In particular, a system may analyze the surface of a user's hand to determine skin properties or characteristics, such as color markings on the back of the user's hand, and may perform user recognition based on those properties or characteristics.

### Example Environment

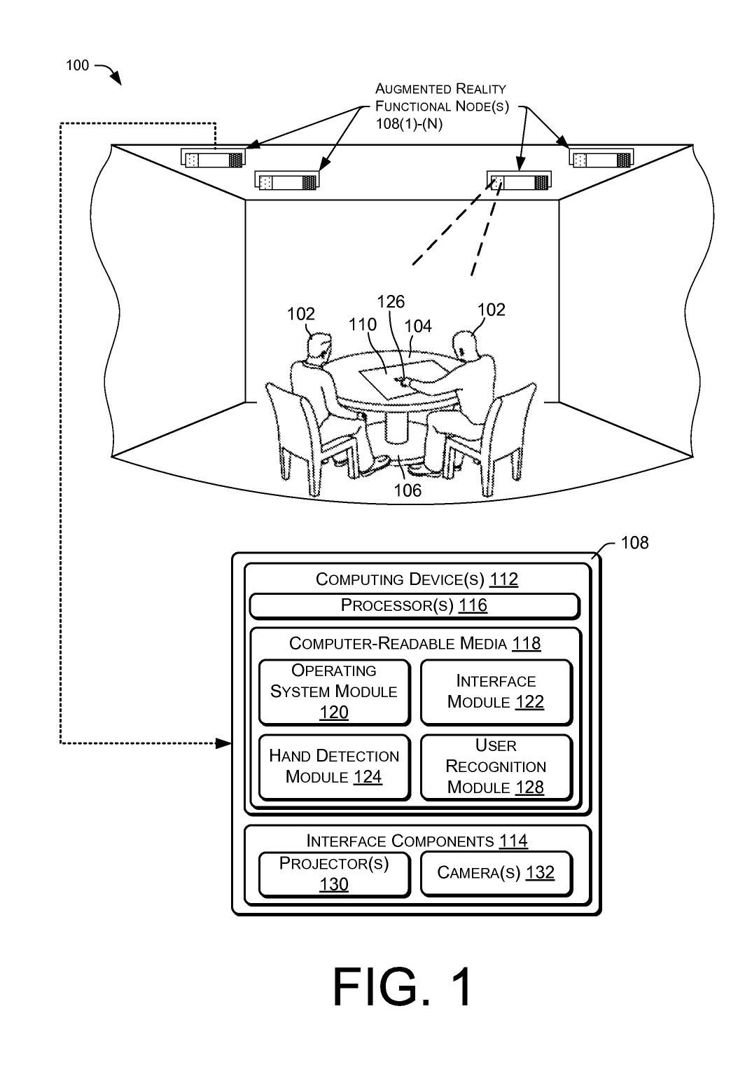

FIG. 1 illustrates an example environment 100 in which one or more users 102 view content that is projected onto a display area or surface 104, which in this example may comprise the horizontal top surface of a table 106. The content may be generated and projected by one or more augmented reality functional nodes (ARFNs) 108(1), . . . , 108(N) (collectively referred to as “the ARFN 108” in some instances). It is to be appreciated that the techniques described herein may be performed by a single ARFN, by a collection of any number of ARFNs, or by any other devices or combinations of devices.

The projected content may include any sort of multimedia content, such as text, color images or videos, games, user interfaces, or any other visual content. In some cases, the projected content may include interactive content such as menus, controls, and selectable or controllable objects.

In the illustrated example, the projected content defines a rectangular display area or workspace 110, although the display area 110 may be of various different shapes. Different parts or surfaces of the environment may be used for the display area 110, such as walls of the environment 100, surfaces of other objects within the environment 100, and passive display surfaces or media held by users 102 within the environment 100. The location of the display area 110 may change from time to time, depending on circumstances and/or in response to user instructions. In addition, a particular display area, such as a display area formed by a handheld display surface, may be in motion as a user moves within the environment 100.

Each ARFN 108 may include one or more computing devices 112, as well as one or more interface components 114. The computing devices 112 and interface components 114 may be configured in conjunction with each other to interact with the users 102 within the environment 100. In particular, the ARFN 108 may be configured to project content onto the display surface 104 for viewing by the users 102.

The computing device 112 of the example ARFN 108 may include one or more processors 116 and computer-readable media 118. The processors 116 may be configured to execute instructions, which may be stored in the computer-readable media 118 or in other computer-readable media accessible to the processors 116. The processor(s) 116 may include digital signal processors (DSPs), which may be used to process audio signals and/or video signals.

The computer-readable media 118 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the computing device 112. The computer-readable media 118 may reside within a housing of the ARFN, on one or more storage devices accessible on a local network, on cloud storage accessible via a wide area network, or in any other accessible location.

The computer-readable media 118 may store various modules, such as instructions, datastores, and so forth that are configured to execute on the processors 116. For instance, the computer-readable media 118 may store an operating system module 120 and an interface module 122.

The operating system module 120 may be configured to manage hardware and services within and coupled to the computing device 112 for the benefit of other modules. The interface module 122 may be configured to receive and interpret commands received from users 102 within the environment 100, and to respond to such commands in various ways as determined by the particular environment.

In addition to other functional modules not shown, the computer-readable media 118 may include a hand detection module 124 that is executable to detect one or more hands within the environment 100 or within the display area 110. For example, the hand detection module 124 may detect the presence and location of a hand 126 of a user, which in this example is placed directly over the display area 110.

The computer-readable media 118 may also include a user recognition module 128 that is executable to recognize users based on optical or visual characteristics of their hands, such as visible skin characteristics. In particular, the user recognition module 128 may implement the techniques described below for recognizing users based on skin properties of their hands.

The computer-readable media 118 may contain other modules, which may be configured to implement various different functionality of the ARFN 108.

The ARFN 108 may include various interface components 114, such as user interface components and other components that may be used to detect and evaluate conditions and events within the environment 100. As examples, the interface components 114 may include one or more projectors 130 and one or more cameras 132 or other imaging sensors. The interface components 114 may in certain implementations include various other types of sensors and transducers, content generation devices, and so forth, including microphones, speakers, range sensors, and other devices.

The projector(s) 130 may be used to project content onto the display surface 104 for viewing by the users 102. In addition, the projector(s) 130 may project patterns, such as non-visible infrared patterns, that can be detected by the camera(s) 132 and used for analysis, modeling, and/or object detection with respect to the environment 100. The projector(s) 130 may comprise a microlaser projector, a digital light projector (DLP), cathode ray tube (CRT) projector, liquid crystal display (LCD) projector, light emitting diode (LED) projector or the like.

The camera(s) 132 may be used for various types of scene analysis, such as by using shape analysis to detect and identify objects within the environment 100. In some circumstances, and for some purposes, the camera(s) 132 may be used for three-dimensional analysis and modeling of the environment 100. In particular, structured light analysis techniques may be based on images captured by the camera(s) 132 to determine 3D characteristics of the environment.

The camera(s) 132 may be used for detecting user interactions with the projected display area 110. For example, the camera(s) 132 may be used to detect movement and gestures made by the user's hand 126 within the display area 110. Depending on the environment and the desired functionality of the ARFN 108, the camera(s) may also be used for other purposes, such as for detecting locations of the users themselves and detecting or responding to other observed environmental conditions.

The coupling between the computing device 112 and the interface components 114 may be via wire, fiber optic cable, wireless connection, or the like. Furthermore, while FIG. 1 illustrates the computing device 112 as residing within a housing of the ARFN 108, some or all of the components of the computing device 112 may reside at another location that is operatively connected to the ARFN 108. In still other instances, certain components, logic, and/or the like of the computing device 112 may reside within a projector or camera. Therefore, it is to be appreciated that the illustration of the ARFN 108 of FIG. 1 is for illustrative purposes only, and that components of the ARFN 108 may be configured in any other combination and at any other location.

Furthermore, additional resources external to the ARFN 108 may be accessed, such as resources in another ARFN 108 accessible via a local area network, cloud resources accessible via a wide area network connection, or a combination thereof. In still other instances, the ARFN 108 may couple to and control other devices within the environment, such as televisions, stereo systems, lights, and the like.

In other implementations, the components of the ARFN 108 may be distributed in one or more locations within the environment 100. For example, the camera(s) and projector(s) may be distributed throughout the environment and/or in separate chasses.

In operation, the ARFN 108 may project an image onto the display surface 104, and the area of the projected image may define the display area 110. The ARFN 108 may monitor the environment 100, including objects appearing above the display area 110 such as hands of users. Users may interact with the ARFN 108 by gesturing or by touching areas of the display area 110. For example, a user 102 may tap on a particular location of the projected content to focus on or enlarge that area of the content. The ARFN 108 may use its various capabilities to detect hand gestures made by users 102 over or within the display area 110, or within other areas of the environment 100. In addition, the user recognition module 128 may analyze captured images of the environment 100 in order to determine skin characteristics of the user's hand 126, and to recognize the user based on such skin characteristics.

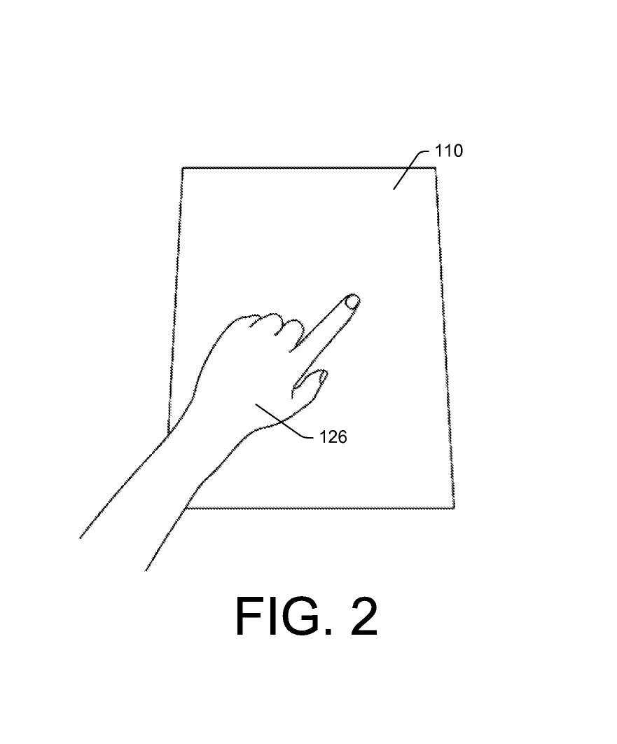

FIG. 2 shows an example of a user interacting within the display area 110. In particular, FIG. 2 shows the hand 126 of the user 102, performing a gesture over the display area 110. The hand 126 may have distinctive optical or visual properties, such as colorations, marks, patterns, and so forth.

When responding to gestures made by a user, the ARFN 108 may account for the identity of the user making the gesture, and may respond differently depending on the identity of the user. In some situations, the ARFN 108 may authenticate users based on the user recognition techniques described herein, and may allow certain types of operations only when instructed by authenticated and authorized users. In other situations, user recognition may be used to distinguish between multiple concurrent users 102 within an environment, so that system responses are appropriate for each of the multiple users.

### User Recognition

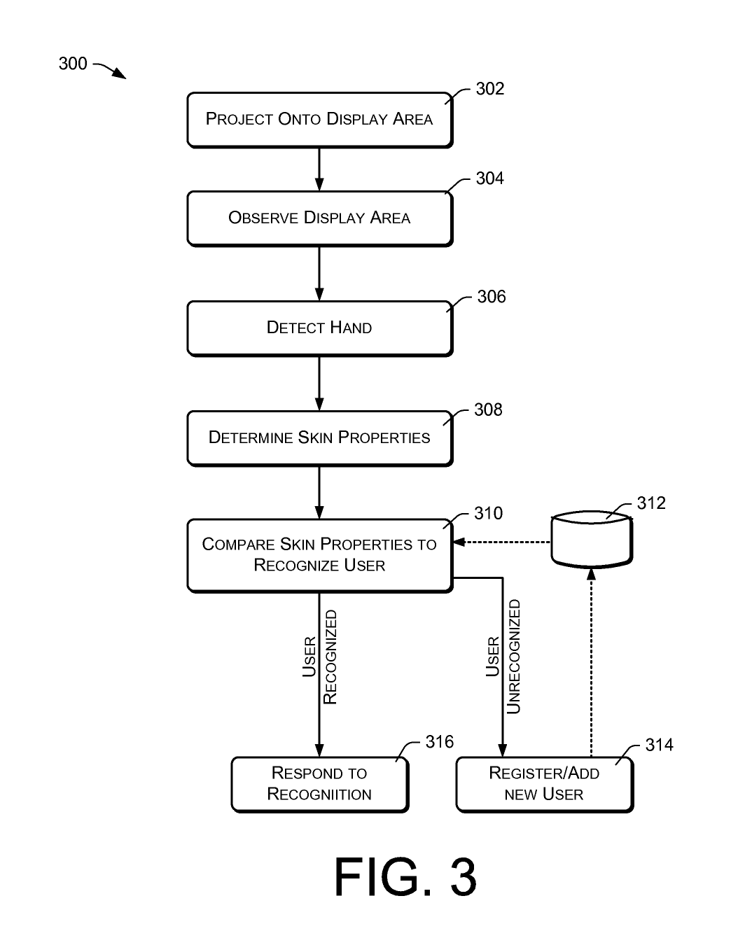

FIG. 3 illustrates an example method 300 of recognizing a user 102 in the environment 100 shown by FIG. 1. Although the example method 300 is described in the context of the environment 100, the described techniques, or portions of the described techniques, may be employed in other environments and in conjunction with other methods and processes.

An action 302 may comprise illuminating or projecting onto the display area 110, from a projector 130 of one of the ARFNs 108. This may include projecting images such as data, text, multimedia, video, photographs, menus, tools, and other types of content, including interactive content. The display area upon which the content is projected may comprise any surface within the environment 100, including handheld devices, walls, and other objects. The display area may in some cases be moveable. For example, the display area may comprise a handheld object or surface such as a blank sheet, upon which the image is displayed. In certain embodiments, multiple users 102 may be positioned around or near the display area, and may use hand gestures to provide commands or instructions regarding the content. Users 102 may also move around the display area as the content is being displayed.

In some situations, the action 302 may include illuminating the display area 110 or some other area of interest with a uniform illumination to optimize subsequent optical detection of hand and skin characteristics. This may be performed as a brief interruption to the content that is otherwise being projected. Alternatively, the action 302 may comprise illuminating the display area 110 with non-visible light, such as infrared light, concurrently with displaying visual content. In some cases, the display area 110 or other area of interest may be illuminated using a visible or non-visible light frequency that has been selected to optimally distinguish particular characteristics. In some cases, uniform illumination may be projected between frames of projected content. In yet other cases, ambient lighting may be used between frames of projected content, or at times when content is not being projected.

An action 304 may comprise observing or imaging the display area 110, such as by capturing one or more images of the display area 110. This may be performed by various components of the ARFN 108, such as by the camera(s) 132 of the ARFN 108 and associated computational components such as the processor(s) 116. For example, a still image of the display area 110 may be captured by the camera(s) 132 and passed to the hand detection module 124 for further analysis. Capture of such a still image may in certain embodiments be timed to coincide with illumination of the display area 110. For example, the still image may be captured in synchronization with projecting a uniform illumination onto the display area 110, or with projecting a predefined light frequency that emphasizes certain skin features or characteristics. In some cases, it may be possible to capture the still image between frames of any content projected by the action 302, taking advantage of projected or ambient lighting. The captured image may be an image of or based on either visual light or non-visible light, such as infrared light that is reflected from the display area 110.

An action 306, which may be performed by the hand detection module 124 in response to an image provided from the camera(s) 132, may comprise detecting the presence and/or location of the hand 126 within the display area 110. Hand detection may be performed through the use of various image processing techniques including shape recognition techniques and hand recognition techniques.

An action 308, which may be performed by the user recognition module 128 in response to detection of the hand 126 by the hand detection module 124, may comprise analyzing an image of the hand 126 in order to determine skin properties or other visual characteristics of the hand 126. In certain embodiments, the back of the hand 126 may be visible to the camera(s) 132 when the user is gesturing, and the action 308 may be performed by analyzing portions of a captured image representing the back of the hand 126. The analyzed image may comprise a two-dimensional image, and may comprise a color image or a black-and-white image. The image does not need to convey non-optical shape or texture characteristics.

Detected skin properties may include any visual or optical characteristics including characteristics such as, but not limited to, the following:
tone and/or color;
texture;
scars;
natural marks including freckles, liver spots, moles, etc.;
vessels and capillaries;
wrinkles;
color markings;
applied markings such as tattoos;
hair;
hair density;
hair color; and
lines and patterns formed by any of the above.

The skin properties may also include markings that have been applied specifically for the purpose of user recognition. For example, tattoos or other markings may be applied in patterns that are useful for identifying users. In some situations, markings may be used that are invisible in normal lighting, but which become visible under special lighting conditions such as infrared illumination.

The skin properties may be evaluated using two-dimensional analytic techniques, including optical techniques and various types of sensors, detectors, and so forth. Skin properties may be represented by abstract and/or mathematical constructs such as features, functions, data arrays, parameters, and so forth. For example, an edge or feature detection algorithm may be applied to the back of the hand 126 to detect various parameters relating to edges or features, such as number of edges/features, density of edges/features, distribution of edges/features relative to different portions of the hand, etc. Although such features may correspond to various types of skin characteristics, it may not be necessary to identify the actual correspondence between features and skin characteristics. Thus, edge or feature detection may be used to characterize the surface of a hand without attempting to classify the nature of skin characteristics that have produced the detected edges or features.

As another example, a characteristic such as skin tone may be represented as a number or as a set of numbers corresponding to relative intensities of colors such as red, blue, and green.

An action 310, performed by the user recognition module 128 in response to the action 308 of determining the skin properties of the hand 126, may comprise recognizing the user 102, such as by comparing the determined skin properties with hand skin properties of known users, which have been previously stored in a data repository or memory 312 that is part of or accessible to the ARFN 108. The comparison 310 determines whether the detected skin properties match those of previously detected or known users. If the user is recognized, the ARFN may proceed with gesture recognition and/or other actions as appropriate to the situation. Otherwise, if the user is not recognized, an action 314 may be performed, comprising adding and/or registering a new user and associating the new user with the detected skin properties. This may include storing user information, including hand skin properties, in the data repository or memory 312 for future reference.

The method of FIG. 3 may be performed iteratively to dynamically detect and/or recognize users within the environment 100.

If the user is recognized in the comparison of action 310, an action 316 may be performed, comprising responding to the recognition of the user. The ARFN 108 may be configured to respond in various ways, depending on the environment, the situation, and the functions to be performed by the ARFN 108. For example, content that is presented in the environment may be controlled in response to user recognition, such as by selecting content to present based on the identity or other properties of the recognized user.

In some situations, the recognition may be performed in order to identify a current user, so that actions may be customized based on the user's identify. For example, a user may request the ARFN 108 to display a schedule, and the ARFN 108 may retrieve the schedule for the particular user who has initiated the request.

In other situations, the recognition may be performed to distinguish between multiple concurrent users of a system. In situations such as these, different users may be controlling or interacting with different functions or processes, and the system may associate a user gesture with a particular process depending on which of the users has made the gesture.

In yet other situations, the recognition may be performed for authenticating a user, and for granting access to protected resources. For example, a user may attempt to access his or her financial records, and the ARFN may permit such access only upon proper authentication of the user. Similarly, the ARFN may at times detect the presence of non-authorized users within an environment, and may hide sensitive or protected information when non-authorized users are able to view the displayed content.

Although the user recognition techniques are described above as acting upon hands that are gesturing within a display area, similar techniques may be used in different types of environments. For example, a system such as the ARFN 108 may be configured to perform recognition based on hands that appear at any location within an environment, or at locations other than the display area 110. In other embodiments, a user may be asked to position his or her hand in a specific location in order to obtain and image of the hand and to determine its skin properties.

### CONCLUSION

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
one or more processors;
an imaging sensor;
a projector;
one or more computer-readable media storing computer-executable instructions that, when executed by the one or more processors, cause the one or more processors to perform acts comprising:
projecting content onto a display area with the projector;
capturing one or more images of the display area with the imaging sensor;
analyzing the one or more images to determine skin properties of a hand of a user within the display area based at least in part on the one or more captured images, the skin properties including one or more visible characteristics of the skin; and
recognizing a user based on the determined skin properties.

2. The system of claim 1, the acts further comprising controlling the content in response to recognizing the user.

3. The system of claim 1, wherein analyzing the one or more images includes applying a feature detection algorithm to the one or more images to determine a location of one or more of the skin properties on the hand of the user.

4. The system of claim 1, wherein recognizing the user comprises one or more of the following:
identifying the user;
distinguishing the user from among multiple users; or
authenticating the user.

5. The system of claim 1, the acts further comprising projecting non-visible light onto the display area in conjunction with the content, wherein the non-visible light reflects from the hand, and wherein the one or more captured images comprise images of the reflected non-visible light.

6. The system of claim 1, wherein the skin properties comprise one or more of the following:
tone and/or color;
texture;
scars;
natural marks;
applied markings;
wrinkles;
hair;
hair density;
hair color;
lines; or
patterns.

7. A method of user recognition, comprising:
capturing an image of a hand of a user;
determining skin properties of the hand based at least in part on the image;
recognizing the user based at least in part on the determined skin properties of the hand; and
controlling presentation of content in response to recognizing the user.

8. The method of claim 7, wherein the controlling comprises selecting the content based at least in part on recognizing the user.

9. The method of claim 7, wherein recognizing the user comprises comparing the determined skin properties with previously determined skin properties of multiple users.

10. The method of claim 7, wherein the image is of the back of the hand.

11. The method of claim 7, wherein the image comprises a two-dimensional image of the hand.

12. The method of claim 7, wherein recognizing the user comprises one or more of the following:
identifying the user;
distinguishing the user from among multiple users; or
authenticating the user.

13. The method of claim 7, further comprising illuminating the hand with non-visible light to produce a non-visible light image, wherein the image shows the non-visible light image.

14. The method of claim 7, wherein the skin properties comprise one or more color markings.

15. The method of claim 7, wherein the skin properties comprise one or more of the following:
tone and/or color;
texture;
scars;
natural marks;
applied markings;
wrinkles;
hair;
hair density;
hair color;
lines; or
patterns.

16. One or more computer-readable media storing computer-executable instructions that, when executed by one or more processors, cause the one or more processors to perform acts comprising:
detecting a hand within an area;
analyzing the hand to determine one or more skin properties of the hand;
recognizing a user based on the one or more skin properties of the hand; and
controlling presentation of content in response to recognizing the user.

17. The one or more computer-readable media of claim 16, wherein the controlling comprises selecting the content based at least in part on recognizing the user.

18. The one or more computer-readable media of claim 16, wherein recognizing the user comprises comparing the determined skin properties with previously determined skin properties of multiple users.

19. The one or more computer-readable media of claim 16, wherein recognizing the user comprises one or more of the following:
identifying the user;
distinguishing the user from among multiple users; or
authenticating the user.

20. The one or more computer-readable media of claim 16, the acts further comprising capturing an image of the area, wherein the detecting comprises detecting the hand within the image.

21. The one or more computer-readable media of claim 16, wherein the analyzing includes applying a feature detection algorithm to the one or more images to determine a location of one or more of the skin properties on the hand of the user.

22. The one or more computer-readable media of claim 16, the acts further comprising:
illuminating the hand with non-visible light to produce a non-visible light image of the area;
capturing the non-visible light image of the area;
wherein the detecting comprises detecting the hand within the non-visible light image.

23. The one or more computer-readable media of claim 16, wherein the skin properties comprise one or more color markings.

24. The one or more computer-readable media of claim 16, wherein the skin properties comprise one or more of the following:
tone and/or color;
texture;
scars;
natural marks;
applied markings;
wrinkles;
hair;
hair density;
hair color;
lines; or
patterns.
